(19) United States
(12) Patent Application Publication
(10) Pub. No.: US 2001/0005829 A1
(43) Pub. Date: Jun. 28, 2001

(54) System and method for managing customer relationships over a distributed computer network

(76) Inventor: William M. Raveis JR., Fairfield, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 09/759,621

(22) Filed: Jan. 11, 2001

Related U.S. Application Data
(63) Continuation-in-part of application No. 09/459,234, filed on Dec. 10, 1999.
(60) Provisional application No. 60/175,397, filed on Jan. 11, 2000.

(51) Int. Cl. G06F 17/60

(52) U.S. Cl. 705/1

(57) ABSTRACT

A system and method of managing customer relationships throughout a real estate transaction cycle over a distributed computer network. The method includes the steps of receiving and storing data relating to a plurality of customers including buyers and sellers of real estate in a computerized database. The data includes active order data describing real estate related services ordered during the real estate transaction cycle, completed order data describing real estate related services completed during the real estate transaction cycle and scheduling data describing real estate related services scheduled during the real estate transaction cycle. The method further includes the steps of updating the active order data, the completed order data and the scheduling data upon the performance of a real estate related service ordered during the real estate transaction cycle and providing customers with secure access to the computerized database to facilitate monitoring of the active order data, the completed order data and the scheduling data.

### CROSS REFERENCE TO RELATED APPLICATIONS

This application is a continuation-in-part of U.S. patent application Ser. No. 09/459,234, filed Dec. 10, 1999 and claims priority to U.S. Provisional Patent Application Ser. No. 60/175,397, filed Jan. 11, 2000, both of which are incorporated herein by reference in their entireties, respectively.

### BACKGROUND OF THE INVENTION

1. Field of the Invention

The subject invention relates to managing customer relationships, and more particularly, to a system and method for identifying, offering and ordering goods and services related to real estate for customers.

2. Background of the Related Art

The traditional business model for real estate companies has been to list and sell properties with a sales force of independent contractors, e.g., real estate agents. It should be recognized that “agent” (both listing and selling), “real estate agent”, “sales agent”, “broker” and the like are used interchangeably throughout the specification. Real estate agents generally have been the main interface for customers. Real estate companies have exclusively provided real estate agents, tours of properties on the market, submission of bids and information about schools and neighborhoods.

Typically, real estate agents supplied only information relating to the purchase and sale of a home. For example, agents conduct assessments of a home to determine an appropriate listing price. Further, an agent may provide several suggestions such as repairs and clean-ups which may enhance the curb appeal and value of a home. Thus, a sale of the home is facilitated as well as a return on the investment in clean-up and repair.

The widespread use of personal computers, modems and data connections has allowed the growth of computer networks. The Internet serves as an example of a type of computer network, and indeed, is a large network of networks, all inter-connected, wherein electronic mail, file transfer, remote log-in and other services are offered. The Internet uses a client-server architecture which is a network-based system that uses client software running on one computer to request a specific service, and uses corresponding server software running on a second computer to provide access to a shared resource managed by the second computer. The second computer then connects to the Internet, which provides the specific service requested.

In 1989 the World Wide Web (hereinafter the “Web”) was developed by English computer scientist Timothy Berners-Lee to enable information to be shared among internationally dispersed teams of researchers at the European Organization for Nuclear Research. The Web is an application program which runs on individual computers and creates connections to multiple different source computers over one or more networks. Web files are formatted using Hypertext Markup Language (HTML) and Web communications occur using the Hypertext Transfer Protocol (HTTP). The Web is a component of the Internet which allows Internet addressable resources to be connected to one another. The concept of connectivity was originally conceived by Ted Nelson in the mid 1960s as a method for making computers respond to the way humans think and require information. In Web parlance, the Web connections are called links or hyperlinks. The server that contains the files is called a Web site. Web sites contain documents which are called Web pages. Web pages are displayed on a computer screen as agglomerations of text and images. Additionally, sound can accompany the Web pages. On Web pages, hyperlinks may be displayed as text, typically in blue, or as a graphic icon. Users operating client computers interact with the Web by utilizing application programs known as Web browsers. When connected to a Web site, users, e.g., clients interact with Web pages by using a mouse and pointing and clicking on visual objects on the screen.

The Internet is growing exponentially and becoming an essential component of everyday life. Businesses are utilizing it to access and distribute information and increase communication both internally and externally. Millions of people currently use the Web for purposes as varied as buying cars, theatre tickets, clothes, selling antiques, collectibles and real estate, reading the news of the day and sending and receiving electronic mail. Access to the Internet via wireless means is also possible to allow interaction from virtually anywhere, anytime.

Such proliferation of the Internet has presented an additional challenge to the traditional business model for selling real estate. The low overhead distribution of information via the Internet has created alternatives to the traditional real estate company. Customers are increasingly acquiring traditional real estate company services via the Internet without engaging a real estate agent or company. As a result, the Internet has caused a downward pressure on broker commissions and increased competition for customers. Therefore, real estate companies require an improved system and method which adds value for their customers, allows customers full access to information, justifies commissions and establishes and maintains a long-term relationship with the customer.

Several attempts have been made to try and improve upon systems for managing information and, in particular, information relating to a real estate company. For example, U.S. Pat. No. 5,664,115 to Fraser discloses a system for matching buyers and sellers of real estate. The system of Fraser stores a set of records corresponding to property listings. A potential buyer can access the system, via the Internet, and search the property listings according to sorting criteria. The system provides the records which meet the sorting criteria to the buyer. Further, the seller may input criteria, such as cash on hand, to narrow the prospective buyers which their listing may be shown. If the transaction is ultimately consummated, the buyer and/or seller may pay a fee to the system operator.

U.S. Pat. No. 5,584,025 to Keithley et al. teaches a system for processing demographic information. The system tracks when, where and how an advertisement was viewed and compiles related statistics. In a real estate related application, the system would provide agents and clients information about each other, listings and communities. Clients can contact responsible parties via telephone. A Transaction Processing Database tracks appointments and significant dates. The Agent Market Data Database is a compilation of inventory and sales reports. The Real Estate Related Services Database and the Home Services Database are compilations of vendors of real estate related services. As a result of the traffic to the system, demographic information is generated which allows targeted marketing to potential customers early in their decision process.

Further, U.S. Pat. No. 5,309,355 to Lockwood discloses an apparatus for composing individualized sales presentations from customer profiles. The sales presentations are multi-media presentations composed from a database of presentation segments arranged in categories. U.S. Pat. No. 5,680,305 to Apgar, IV discloses a system which provides business real estate reports. The reports present data related to a real estate portfolio held by a business in order to allow the business to assess the efficiency with which money is spent on real estate. The reports are calculated from a database which contains information relating to the real estate holdings of the company.

Despite their success, current business models for real estate companies have several shortcomings. Often, the homeowner is left trying to manage repairs and improvements with little more than a telephone book for assistance. Further, customer relationships are not maintained throughout the lifetime of the customer. As a result, the customer may engage several real estate companies and even more sales agents throughout their lifetime.

Furthermore, investments in technology to overcome some of these barriers above can be cost prohibitive even for larger organizations. Under these circumstances, a further need exists for a proven way to manage customer relationships, which is easy to implement and use, and yet affordably priced so that small size organizations can take advantage thereof. Moreover, the system and method would utilize the Internet to provide full-time remote access and efficient storage and transfer of information.

In view of the above deficient systems and methods for managing real estate related relationships, there is a need in the art for an improved system and method for effectively and profitably managing the customer relationships of a real estate company. Particularly, it would be beneficial to provide a system and method which utilizes a distributed computing network to facilitate managing customer relationships and the information appertaining thereto.

### SUMMARY OF THE INVENTION

The subject invention is directed to a system and method for managing customer relationships throughout a real estate transaction cycle over a distributed computer network.

The method includes the steps of receiving and storing data relating to a plurality of customers including buyers and sellers of real estate in a computerized database. The data includes active order data describing real estate related services ordered during the real estate transaction cycle, completed order data describing real estate related services completed during the real estate transaction cycle and scheduling data describing real estate related services scheduled during the real estate transaction cycle. The method further includes the steps of updating the active order data, the completed order data and the scheduling data upon the performance of a real estate related service ordered during the real estate transaction cycle and providing customers with secure access to the computerized database to facilitate monitoring of the active order data, the completed order data and the scheduling data.

In one embodiment, the method further includes the steps of receiving and storing real estate related documents in the database for subsequent review and retrieval by a customer as well as receiving and storing mortgage data relating to terms of a mortgage executed during the real estate transaction cycle. In another embodiment, the method further includes the step of providing a customer with an electronic checklist associated with each of a plurality of phases of the real estate transaction cycle to enable the customer to order real estate related services.

These and other unique features of the system and method disclosed herein will become more readily apparent from the following description and the accompanying drawings.

### BRIEF DESCRIPTION OF THE DRAWINGS

So that those having ordinary skill in the art to which the disclosed system and method appertains will more readily understand how to make and use the same, reference may be had to the drawings wherein:

FIG. 1 is an overview of an environment in which an embodiment of the present invention may be used;

FIG. 2 is a graphical overview of the partitioning of a Web site in accordance with an embodiment of the present disclosure;

FIG. 3 is an example of a Web page relating to an activity file in accordance with an embodiment of the present disclosure;

FIG. 4 is an example of a Web page relating to vendor information in accordance with an embodiment of the present disclosure;

FIG. 5 is an example of a Web page relating to services sold to a member in accordance with an embodiment of the present disclosure;

FIG. 6 is an example of a Web page relating to a service evaluation form in accordance with an embodiment of the present disclosure; and

FIG. 7 is a flowchart depicting a process for managing contact relationships relating to real estate in accordance with an embodiment of the present invention.

### DETAILED DESCRIPTION OF THE PREFERRED EMBODIMENT

The present invention provides a system and method for managing customer relationships relating to real estate transactions. The system and method allows sales, management and administrative personnel of a real estate company to gather, process, provide and utilize data relating to contacts, listings and vendors in an efficient and profitable manner. In the description that follows, the terms “Contacts” and “members” are used interchangeably. Contacts and members shall refer to buyers and sellers of real estate who have engaged a proprietor of the subject system and method. Additionally, the system and method provide contacts with convenient access to information relating to their real estate transactions and vendors of goods and services.

In accordance with a preferred embodiment of the system, each of a plurality of different users perform different functions. Users are people who interact with the subject system and method. For example, the real estate company, sales agent and contacts access information relating to real estate transactions stored in a database. In particular, administrative personnel monitor activity related to a listing. Contacts who are sellers of real estate are associated with a listing. A listing is a property that is offered for sale. Further, the administrative personnel provide reminders and available goods and services, preferably at a discount to contacts, by utilizing the system and method of the subject invention. Further, a proprietor of the subject system and method can maintain a center of administrative personnel to allow small real estate companies access on a rental basis.

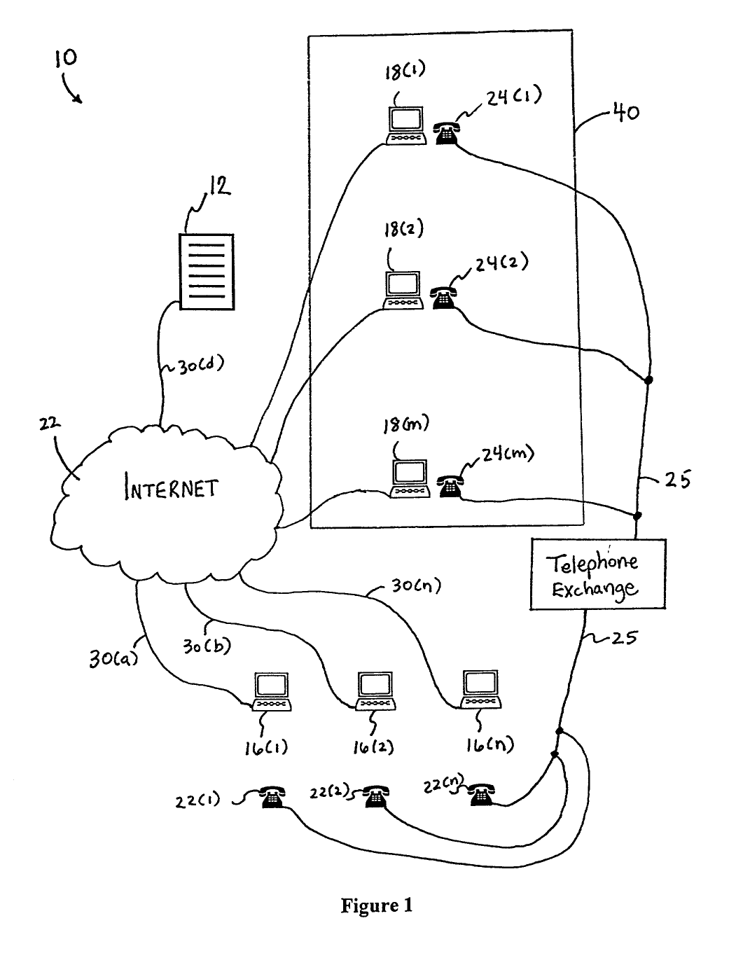

Referring to FIG. 1, there is illustrated a schematic representation of an environment 10 in which the system and method of the present invention may be implemented. Environment 10 includes server 12, which communicates with a distributed computer network 22. Server 12 hosts multiple web sites, houses multiple databases and runs the software to support the system and method of the subject invention.

It is envisioned that environment 10 may incorporate one server or multiple servers to achieve the desired performance necessary from server 12. Multiple servers can cooperate to facilitate greater performance and stability of the subject invention by distributing memory and processing. U.S. Pat. No. 5,953,012 to Venghte et al. describes a method and system for connecting to, browsing and accessing computer network resources and is herein incorporated by reference in its entirety. Similarly, U.S. Pat. No. 5,708,780 to Levergood et al. describes an Internet server which controls and monitors access to network servers and is also herein incorporated by reference in its entirety.

In a preferred embodiment, the memory of the servers stores a multiplicity of databases. The databases contain data relating to advertising, sales agents, contacts, listings, vendors, and the real estate company. It is envisioned that advertising databases relate to advertising copy, advertising companies, advertising placements and advertising requests by contacts and sales agents databases relate to sales agents, agent financial information, appointments, agent goals, goal weighting, agent MLS codes and agent phone numbers. Databases for contacts preferably consist of tables relating to contacts, contact mailings, contact referrals and contact types. Listing databases preferably relate to listings, listing agent, listing MLS, lock boxes, MLS, MLS data, open house requests, picture references, garages, new home referral fees and showing information. Vendor databases preferably relate to relocation companies, relocation fee percentages, relocation company phone numbers, signs, sign vendors, mailings to vendors and the like. Real estate company databases preferably consist of attorneys, commission splits, company commissions, forms, types of mass activities, report tables, sale transactions, sales agents, sale commissions, sale contact, security, sellers attorney, offices, office commission fees, office MLS, office phone, regions, region commissions, surveys, survey choices, survey questions, survey response, system identifiers, system tables, trustee tracking, user messages, user roles and user sessions. In a preferred embodiment, the databases are used in a relational arrangement so that they relate to one another by way of fields that store common data.

Distributed computer network 22 may include any number of network systems. For example, distributed computer network 22 may be a combination of local area networks (LAN), wide area networks (WAN), intranets or the Internet, as is well known. In the preferred embodiment, the computer network 22 is the Internet. The preferred method of accessing information on the Internet is the World Wide Web, because navigation is intuitive and does not require technical knowledge.

Client computers 16(1)-16(n) are associated with users. When used herein, variables such as “n” and “m” are in no way intended to limit the real or potential number represented. Users of the subject invention include contacts, sales agents and personnel associated with a real estate company. The real estate company engages sales agents who manage the contacts. Personnel associated with the real estate company may be any combination of a technical system analyst, a move consultant, a sales manager, accounting personnel and the like, who work directly or indirectly for a real estate company.

In a preferred embodiment, a plurality of move consultants are associated with consultant computers 18(1)-18(m). The consultant computers 18(1)-18(m) are located at a central location or call center 40. Preferably, the proprietor of the subject invention provides or causes to be provided server 12, call center 40 and the personnel necessary thereto to maintain the proprietor's relationship with its contacts. In another embodiment, a central entity creates call center 40 in order to rent capacity to a multitude of real estate companies. Thus, smaller real estate companies, which would not otherwise be able to afford the benefits offered by the subject invention, can lease the service provided by call center 40 in proportion to usage. Further, a single contact database is created which includes all the contacts for all the real estate companies and entities who utilized the subject system and method.

A plurality of users may share the same client computer 16(1)-16(n) and consultant computer 18(1)-18(m). The plurality of users can utilize the system 10 simultaneously from the same location or a variety of locations. The computers 16(1)-16(n) allow users to access information on the server 12. The computers 16(1)-16(n) communicate with the distributed computing network 22 via communication channels 30(1)-30(n), respectively. The communication channels 30(1)-30(n), whether wired or wireless, are well known and therefore not further described herein. It is also envisioned that users can communicate with server 12 by a direct connection thereby alleviating the need for authentication. Preferably, the consultant computers 18(1)-18(m) of call center 40 are only available to personnel employed by the proprietor.

The users can communicate with the move consultants via email over distributed computer network 22. Additionally, users can communicate with the move consultants over telephones 22(1)-22(n) using standard telephone lines as represented generally by connection 25. When a move consultant communicates with a user over telephone 24(1)-24(n), the move consultant enters comments into a computerized database in server 12 documenting the communication with the user.

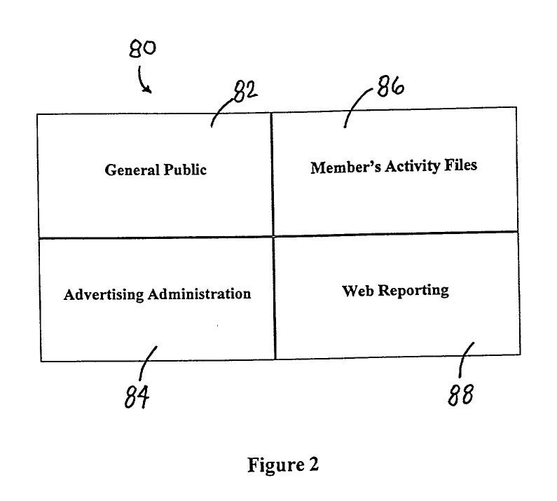

Referring now to FIG. 2, a schematic diagram of a Web site 80 configured according to a preferred embodiment of the subject invention is illustrated. Web site 80 has a general public section 82, an advertising administration section 84, an activity files section 86 and a Web reporting section 88. Web site 80 includes a plurality of Web pages, links and the like. Preferably, server 12 hosts the Web site 80 although a single server or multiple servers could host the Web site 80 to increase performance and reliability as required.

### I. General Public Section

General public section 82 is information which can be viewed by any user having a client computer 16(1)-16(n) with a Web browser. Information available to the general public includes a buyer's guide and a seller's guide. Each guide presents Web pages to provide information and resources to assist a contact with every phase of the buying and selling process. It should be recognized by those skilled in the art that the terms “Web page”, “video display” and “screen” may be used interchangeably and are used in this manner throughout the specification.

The buying and selling processes have five phases each. The buying process consists of “thinking”, “looking”, “buying”, “closing” and “post-move” phases. The selling process consists of the “thinking”, “getting ready”, “listing”, “negotiating” and “closing” phases. In particular, the buyer's guide and seller's guide provide information specific to each phase.

a. Buyer's Phase I—Thinking

In one embodiment, the buyer's guide provides information to individuals who are thinking about purchasing a home, i.e., phase one of the buying cycle. A spreadsheet can be provided to aid a user in ascertaining whether they should rent, buy, move or remodel. For example, a table can be provided to compare the cost of moving with that of remodeling. According to the American Homeowners Foundation, the expense of moving is roughly equal to 8 to 10 percent of the selling price of your house. Therefore, if the improvements will cost less than 8 to 10 percent of the resale value of the house and provide the desired qualities, it is more economical to remodel than move. Additionally, remodeling information is provided such as what percentage of the remodeling cost becomes attributed to the value of the home. The percentage being a variable based upon the type of remodeling project. For renters, the Web site provides a mortgage payment correlating to their existing rent payment and for current homeowner considering a move, the Web site clearly explains the circumstances under which the capital gains on the future sale would be treated.

The buyer's guide would also help a contact view current listings of properties through an agent associated with the proprietor or a Multiple Listing Service (hereinafter “MLS”). A MLS is a book which shows available inventory within a local or regional market. Guidelines and calculators are provided to help users determine how much they can afford and what the mortgage payments would be. If the buyer has already participated in the subject invention, a move consultant can offer the goods and services associated with the thinking phase.

b. Buyer's Phase II—Looking

The buyer's guide provides information for individuals who want to actively look for a new home, i.e., phase two of the buying cycle. Information is provided to show the importance of the real estate agent. For example, an agent should be accredited with a reputable organization and provide contacts with a move consultant.

A potential buyer or seller of real estate who engages an agent utilizing the subject system and method becomes a member of the proprietor's program. Engagement typically requires the contact to sign a representation agreement with the proprietor or a real estate company associated with the proprietor. Members are assigned move consultants and given access to restricted portions of Web site 80. The move consultant assists members and agents by coordinating and managing all aspects of the real estate transaction. Within the restricted portions of Web site 80, a contact activity file specific to each member tracks savings, house and mortgage documents, and maintenance in and on the member's past, current and future homes. Thus, when improvements are made, a record is established to demonstrate the value the member added to their home. Further, the electronic copies of title documents and the like alleviate the need for the contact to maintain a safety deposit box for such items.

The agent also serves as the contacts “eyes” and “ears” in the community and represents the contact's interests in matching their lifestyle to their future community or neighborhood. A sales agent maximizes value for the member by listing their home, facilitating purchase of a new home and providing opportunities for savings and convenience through the move event. Further, a link is provided to local agents to allow the user to contact a real estate broker directly or through a move consultant. It should be recognized that “agent”, “real estate agent”, “sales agent” and “real estate broker” are used interchangeably throughout the subject disclosure.

Still referring to the buyer's guide located in general public section 82, the significance of the initial meeting between a user and an agent is also represented by a Web page. At the first meeting, the agent reviews and explains any required forms. Forms may vary from state-to-state so the local agent is most familiar with the required forms. At the first meeting, the agent should also provide disclosure of any real estate agency relationships. The contact should provide the agent with information about desired house style, family needs and an affordable price range. The local agent is the best resource for general information on the community and the most current home values, schools and crime rates in the desired neighborhood. The agent can also help a contact complete an application for pre-qualification at the first meeting if engagement occurs. The benefit of pre-approval at the looking stage is that pre-approval provides a negotiating advantage as a cash-buyer without a mortgage contingency. The move consultant assigned to the contact can arrange for the mortgage pre-qualification from the proprietor or a third party lender.

During phase two of the buying cycle, the agent increases the efficiency of the contact's home search by previewing homes prior to showing it to them. Thus, the contact only tours homes which match the contact's criteria. Further, the agent notifies a move consultant of the member's activity. The sales agent shows houses found by the contact and the agent, whether through the Internet, MLS or the like. Typically, agents are privy to information about houses soon to enter the market before it is general knowledge. Thus, the agent provides their member's with valuable advance knowledge.

c. Buyer's Phase III—Buying

The buyer's guide also provides information for individuals at the stage of buying a new home, i.e., phase three of the buying cycle. In order to buy a property, the contact must make an offer to the seller. The agent can provide the offer or initial contract which is usually pre-printed with fill-in the blank fields. The terms of offer will include sale price, a mortgage contingency clause, necessary inspections and a settlement/closing date. The agent can provide a good estimate as to what the offer should be on a house. Typically, the agent and contact will determine together the offer price based on demand for housing in the particular price range and style and how many houses are currently for sale in the particular price range and style. An agent can even provide a list of list price versus sales price in the neighborhood or general vicinity that occurred in the past six months and how those homes compare to the home under consideration by the buyer. However, the buyer always specifies the amount of the mortgage and the rate. The necessary inspections on the offer can include termite, pest, general home, well, septic, and radon inspections. Preferably, the agent can time the contact's closing date for the end of the month for a grace period of 30 days before the contact's first mortgage payment is due. Additionally, the agent will review seller's disclosures with the contact. Disclosures include any environmental hazards and any previous mechanical or structural problems or changes.

Typically the sales agents negotiate the terms of the purchase contract. If the terms of the offer are acceptable to seller, the purchase contract is signed and becomes binding. If original terms are not accepted, the seller will counter with different terms, different dates and the like which are more favorable to the seller. Most offers are countered because of sales price and closing date. If renegotiated terms are accepted, each of the changes made in the initial contract must be initialed by both buyer and seller. The buyer counter offers and seller counter offers can continue through several revisions.

Upon agreement between the buyer and seller, the move consultant and agent facilitate finding a settlement attorney or escrow agent as needed by the contact. In one embodiment, the move consultant associated with the contact can arrange to have information on loan programs sent to the contact. The proprietor would earn a commission based upon such referrals. In another embodiment, the proprietor would be a licensed mortgage brokers in one more states and provide a mortgage directly to the contact with the assistance of the move consultant.

In order to fulfill the purchase contract commitments, the move consultant coordinates the environmental inspection, home inspection, insurance approval, lender title search and pest inspection. Further, the move consultant arranges appliances, carpeting, flooring, landscaping, painting of the new home and the like for the member. The move consultant offers home warranty on major appliances and home mechanical systems which provides security for the year following the purchase of the new home.

d. Buyer's Phase IV—Closing

In preparation for closing, i.e., phase four of the buying cycle, the move consultant coordinates and orders the services needed including estimates for moving van services and the like. In a preferred embodiment, the goods and services are offered at a discount due to the open market price due to the mass buying power the move consultant represents. Further, the proprietor receives a commission or referral fee from the vendors who provide goods and services through the move consultant. Moreover, the proprietor receives a fee for granting access to the members. Without limitation, the fees can be derived from advertising on the Web site, lists of member contact information and as a result of move consultants offering the vendors goods and services. The lists of member contact information are particularly valuable because new homeowners are a key target demographic for a large number of vendors.

Prior to closing, the agent Sales Agent facilitates a property walk-through. On the walk-through, usually 24 hours prior to closing, the agent usually accompanies the buyer on a final inspection of the home prior to closing. The walk-through ensures all agreed on repairs are completed, all items to be included with house are in the house and the like.

e. Buyer's Phase V—Post-Move

After closing, the buyer enters phase five of the buying cycle. During phase five, the move consultant coordinates delivery of the moving van. As noted above, goods and services provided through the move consultant are preferably offered at a discount and the proprietor receives a referral fee. In particular, the move consultant provides an activated phone or cell phone information to the movers for the movers arrival and insures that someone should be available to meet the movers at the new location to let them in and direct the mover's placement of boxes and furniture. The move consultant also has copies of keys made for each family member.

Moreover, the move consultant facilitates the settling in process by arranging for a security system at a member discount. Additionally, the move consultant may arrange for goods and services such as appliances, decorating, carpeting, painting, curtains, flooring, furniture, interior decorating, lighting, upholstery, remodeling, electrical contractors, plumbing, windows, landscaping, lawn maintenance, dogwalking and the like.

Still referring to general public section 82, the seller's guide provides information to help people understand what is involved when selling a home. Similar to the buyer's guide, the seller's guide helps members maximize the value of their time and assets by outlining important points to consider relating to the various phases of the selling cycle.

f. Seller's Phase I—Thinking

During phase one of the selling cycle, when individuals are thinking about selling a property, the seller's guide provides information regarding agents and financial costs associated with moving. Further, remodeling information is also included to help potential sellers determine if remodeling may be appropriate instead of moving.

g. Seller's Phase II—Getting Ready

For phase two of the selling cycle when the contact is getting ready to sell a home, the selling guide details the appropriate actions for the seller and agent. For example, an agent should conduct an initial walk-through of the seller's home. During the initial walk-through, the agent does a mental market assessment of the home, yard and curb appeal. The agent pays particular attention to improvements that will help the property show well. To maximize the value of the contact's home the agent will explain what needs to be done. Upon determination of a plan to ready the home for showing, the move consultant offers and coordinates delivery of whatever goods and services are necessary such as appliances, home decorating services, carpets, carpet cleaning, cleaning services, floor refinishing, heating and air conditioning system repair, lawn services, painting, general repairs, roofing, siding and the like. Goods and services can be supplied by local and national vendors. Such substantive and cosmetic changes enhance the marketability of the seller's home and provide an adequate return in either market time or potentially a higher price. Market time is the duration of time a listing remains on the market before it is sold. Further, an agent can determine if an inspection should be done in order to make minor repairs in advance to what a buyer's inspection may reveal. As noted above, preferably, the move consultant offers the goods and services at a discount to the open market price and the proprietor earns a referral fee for each item rendered through the move consultant.

Still referring to phase two of the selling cycle, the agent will also explain the listing process to the seller including the terms of a listing contract. The agent also explains disclosure forms and reviews any forms such as agency disclosure or property condition disclosure forms that are required by law.

h. Seller's Phase III—Listing

The first step in the seller listing their property, i.e. phase three of the selling cycle, is to determine the list price of the seller's home. In order to determine the list price of the seller's home, the agent undertakes a market analysis to help determine a listing price. A market analysis evaluates data from historical sales such as demand indicated by what similar homes in the neighborhood have sold for in the past 3-6 months. The more recent the sale, the better comparable the sale is to the seller's home value. The farther from the neighborhood the home is, the less comparable the prior sale is. Market time is also a factor in determining market demand. The supply of similar homes and condition of the seller's home are additional pieces of information to determine market demand. An experienced agents has first hand knowledge of condition of both recently sold homes and current inventory and will point out how they compare to the seller's home. The agent also notes differences between such homes which either impact the sale negatively or positively and ultimately affect the listing price. Ultimately, the agent will suggest to the seller a listing price range to help the seller determine a final list price. A good listing price is one that the seller offers the buying public as their estimation of what the house is worth in comparison to other local housing values.

Once the list price is determined, the seller and the sales agent should develop a home marketing plan. The home marketing plan is more than a listing on the MLS or a display on the Internet. The seller's sales agent will discuss the potential buyer's profile for the home and the best possible marketing plan to attract that buyer.

Of course, the seller is required to sign a listing agreement. The listing agreement defines the listing price, items which are included in the home, terms with the sales agent and the commission that will be paid to the brokerage firm and any cooperating brokerage firms. The broker's commission is negotiable. Each local office associated with the proprietor can prepare their own local seller's guide to use as a sample listing agreement for their clients in the region.

Additionally, a co-broker commission may be required. Typically, the selling broker receives a selling broker commission which is separate from the listing commission the seller's listing broker receives. The total commission, both listing and selling, are then shared with the listing agent and selling agent. Under usual circumstances, the move consultant will arrange a home warranty for the seller. The home warranty covers major appliances and components in the home. A warranty provides peace of mind to the buyer and reduces inspection issues.

i. Seller's Phase IV—Negotiating

Negotiating, the fourth phase of the selling cycle, includes effectuating the marketing plan and negotiating an offer. Submitting the property listing to a MLS is the traditional first step in effectuating the marketing plan. Subsequently, sales agents will schedule appointments to show the property. Often times, a computer listing will go out to all local agents within twenty-four hours of listing, so the seller should be prepared for showings.

Preferably, placement of a “For Sale” sign outside the property is arranged by the move consultant. Upon instruction from the agent or seller, the move consultant contacts a sign vendor associated with the subject business method. The “For Sale” is used to generate interest from observers and may further include a factual sheet containing detailed information regarding the property. Once again, in the preferred embodiment, the sign is posted at a discount and the proprietor receives a referral fee. Thus, the contact saves time and money while the proprietor earns a revenue stream. Further, when a move consultant helps the contact and agent, the agent is free from administrative responsibilities in order to pursue other responsibilities.

Still referring to phase four of the selling cycle, an open house for broker preview can be held. This presents an opportunity for all local real estate agents to see the features of the seller's home. Typically, the sales agent hosts the open house for brokers as well. Therefore, the seller does not need to be present.

To implement the marketing plan, the sales agent and seller will determine a timetable of execution. The sales agent, with the assistance of the move consultant, keeps the seller informed of marketing and showing activity on the property. The sales agent may even hold multiple open house showings for the public. Preferably, the general public open house is held on a weekend and advertised to the general public. Once again, the move consultant facilitates placement of the related advertising. The sales agent hosts the Open House to ensure that there are no unaccompanied prospects in the property.

Upon receipt of an initial offer to purchase or commonly “offer” from a potential buyer, the sales terms must be negotiated. The buyer's sales agent will deliver the offer to purchase to the seller's sales agent. The seller's sales agent reviews offers and forwards them along to the seller for consideration. The offer is usually pre-printed with fill-in the blanks. Typical terms of the offer will include: sales price; mortgage contingency clause; and the buyer specifies the amount of mortgage and the rate. A deposit may also be required to accompany the offer as earnest money. The deposit is usually refunded if the buyer is unable to get a mortgage under the proposed terms.

Similar to phase two of the buying cycle, prior to agreement, necessary inspections may include: general home inspections; pest inspections; radon inspections; septic inspections; termite inspections; and well inspections. An additional term of the agreement may be a settlement closing date.

If terms are acceptable to the seller and the buyer, the contract is signed and becomes binding. If original offer terms are not acceptable, the seller may counter with more favorable terms or dates. As noted above, most offers are countered because of sales price and closing date. Buyer and seller counter offers can continue through several revisions over the course of days, weeks and even months. As noted above, each of the changes made in the initial contract offer must be initialized by both the buyer and the seller once agreed upon.

The sales agents provide a copy of the executed contract to attorneys, escrow agents and the like. The Sales Agent with the assistance of the move consultant keeps the seller updated as to the status of the buyer meeting any contingencies such as, without limitation, the mortgage provision contained in the purchase contract.

j. Seller's Phase V—Closing and Moving

Phase five for the seller is closing and moving. Once again, the move consultant assists the sales agent and seller by tracking information and coordinating goods and services. The sales agent and move consultant communicate a wealth of information to the seller during the closing phase such as buyer status for mortgage commitment and other contingencies. Generally, a mortgage commitment will be approved in 15-30 days. Property inspection results are also tracked by the sales agent with the assistance of the move consultant. If a repair is required, the buyer and seller may negotiate further on the repair issues. Preferably, the move consultant arranges for discount goods and services as may be required to address the repair issues. Thus, a record is maintained which documents the activity of the home. Such maintenance records increase the marketability of the property. Occasionally, the seller will have to offer a home warranty to alleviate the concerns of the buyer. The move consultant will also assist the sales agent in confirming the closing date with the buyer and seller.

Preferably, the move consultant coordinates closing activities such as, for example: moving van services; utility disconnections and new connections for the buyer; and repairs negotiated from the inspection report. In a preferred embodiment, the proprietor of the call center 40 also provides mortgage services and any other possible real estate related good or service. It should be noted that the subject disclosure contemplates that the move consultant always offers members goods and services at a discount and the proprietor always earns a referral fee for goods and services of third party vendors placed through the move consultant.

At the closing, the seller's agent will accompany the buyer and the buyer's agent through the final property inspection. Usually the final property inspection occurs twenty-four hours before the closing date. If all agreed upon repairs are not complete by the final inspection, part of the proceeds from the transaction can be held in escrow. Both the buyer and the seller attend the closing unless the buyer or seller has already processed their requirements of the closing in advance. The buyer's sales agent may also attend the closing at the request of the buyer. The buyer's and seller's attorney attend the closing, which is usually held at the seller's attorney's office or at a mutually agreed location.

At the closing, settlement services may be required to be provided by the seller. Various lenders have forms which outline such required settlement costs. Settlement costs increase the cost of closing. The settlement costs can be between ten to thirteen percent of the total house price. Broker commission is a settlement cost and defined as the total dollar amount of the real estate broker's sales commissions (usually paid by seller). The commission is typically a percentage of the sale price of the home. Fees lenders charge to process, approve and make mortgage loans are also a settlement cost. Another settlement cost would be a loan origination fee which is commonly known as “points”. The points covers the lender's cost to process the loan. Often, the points are charged at the time of application. Loan discounts, also known as points, are one time charges imposed by lender to lower the interest rate at which the lender would otherwise offer the loan. One point is equal to one percent of the mortgage amount. Appraisal fee and credit report fee which shows the buyer's credit history is also a settlement cost. The credit report is used by the lender to determine whether to approve the loan. Through the subject system and method, the move consultant can provide access to several lenders who submit potential mortgages. In another embodiment, the proprietor of the call center is a mortgagor and the move consultant provides a mortgage offer to the buyer from the proprietor. The lender inspection fee and new construction inspection fee are also settlement costs. The mortgage insurance application fee covers processing the application for mortgage insurance as lender require on loans with less than twenty percent of a down payment. An assumption fee is charged when the buyer assumes or takes over the seller's existing mortgage loan. A mortgage broker fee is paid to the mortgage broker for their services. In a preferred embodiment, the proprietor of the call center 40 is a mortgage broker.

Additional fees are usually required by the lender to be paid in advance of closing. For example, the interest on the mortgage loan that accrues from settlement date to the first monthly payment is required to be prepaid. The mortgage insurance premium may require either the first year prepaid or a lump sum that covers the life of the loan when less than twenty percent is used as a down payment. Often, proof of hazard insurance by buyers is required to bring to the closing proof, therefore the first year's policy of hazard insurance is usually prepaid. Lenders may also require a prepayment of flood insurance. Escrow account deposits are also settlement costs. Property taxes are an example of escrow accounts which are set up by the lender. The variety of services performed by title companies or others involved in settlement are also required prior to closing.

It should be noted that the closing and settlement fees noted above are not exhaustive and more or less of such fees may be required as is known to those skilled in the art. For example, a settlement fee paid to the settlement agent or escrow holder may be required. Responsibility for payment of the settlement fee can be owed by the buyer or the seller. An abstract of title search, title examination and a title insurance binder can be required as preparation of final legal papers and, thus, a fee for each may be required. A Notary Fee for notarizing legal documents and Attorney's Fees for legal services provided to the lender may also be charged. The cost of the buyer's and seller's attorney may also appear as a closing or settlement cost. Title Insurance, Lender's Title Insurance and Buyer's Title Insurance are also common costs. The government may require fees for recording and transferring ownership. Most of the noted fees may be paid by the buyer or seller depending on local custom or agreement between the parties. The buyer usually pays fees for recording the new deed and mortgage. Transfer taxes are set by the state or local government. City, county and state tax stamps may have to be purchased. An evaluation of paint hazard risk may also be a required fee. Homeowner Association dues, special assessments, fuel and other utilities will often be allocated and prorated between the buyer and seller. At closing, the seller usually provides keys and access to house unless other arrangements are made. It is envisioned that the move consultant may help with some or all of the fees and tasks above. Further, the proprietor may directly offer such services instead of earning a referral fee.

While most sellers broom clean the home, the move consultant can offer a more thorough cleaning solution such as a professional cleaning service and house painting. Preferably, the services coordinated through the move consultant are provided at a discount price relative to the open market due to the increased leverage resulting from the mass buying power that the proprietor of the call center 40 represents. In one embodiment, the proprietor collects a referral fee from such coordination by the move consultant. Preferably, the move consultant can provide the buyer with any appliance booklets and any other instructions on home mechanical systems at the closing.

In addition, the general public portion 82 of the Web site 80 will provide information about the service provided by the proprietor therethrough. Preferably, the general information will explain the responsibilities of the sales agent and move consultant as well as the features of the Web site 80. Further, portion 82 will allow users to become members through electronic mail.

### II. Advertising Administration Section

Advertising administration section 84 of Web site 90 provides an interface to allow creation of advertisements for posting on Web site 90. Further, advertising administration section 84 allows for managing, editing and deleting the advertisements by an authorized advertising manager. It is envisioned that the advertising manager works for the proprietor of the call center 40. However, it will also be appreciated that access to the advertising administration section 84 may not be restricted to only the advertising manager. Thus, third party entities who utilize the subject invention on a rental basis can create, modify and manage their own advertisements on Web site 80 using the interface. In another embodiment, the advertisements created using the interface can be exported for display on any Web site.

### III. Activity File Section

Activity files section 86 of Web site 80 allows a client to enter a secure environment within which specific information relating to the client is stored in a computerized database. The activity files section 86 securely stores the client's important homeownership papers, creating a financial record of their most important asset. Thus, a record is established to demonstrate the value added by the homeowner to their property.

Preferably, the move consultant assists the member in creating a secure and accessible history or “activity file” in activity files section 86. The activity file organizes and maintains the member's closing and moving schedule. Further, the activity file documents and records all the member's real estate transactions, including closing documents, records of home-related purchases, accounting of expenditures and savings garnered as a result of participation.

Preferably, members use the personal and secure Web pages associated with their activity file as the portal to a multitude of services. The activity file keeps the member up-to-date on every aspect of their move and homeownership. The activity log tracks when products and services will be delivered; when installations, connections and disconnections will be completed; the status of each outstanding product and service ordered by the member; what the member has spent; and what the member has saved by participating in the subject invention. The member uses the activity file to order additional purchases and schedule services, or e-mail their move consultant to manage such tasks for them. The activity file allows the member to maintain and analyze records for all transactions related to their home ownership whether the contact is buying, selling or enjoying a home. Access via the Internet is secure and always accessible. Further, the activity file stores mortgage papers, closing and settlement documents, records of home-related purchases and property taxes for the contact. The activity file tracks the contact's purchases from vendors who participate within the subject invention. The records established in the activity file accurately document the value added to a contact's home which facilitates resale and refinancing. Still further, the activity file serves as a home maintenance organizer. In particular, the contact can record details about their heating, air conditioning, pool, and other systems. When given permission, a member can be notified when such systems need service and about member discounts for that service. If desired, the move consultant can schedule the service call for the member. Additionally, the activity file can be a personal organizer for the member. Birthdays, anniversaries, vacations, other like events can be stored within the activity file. The subject invention and the move consultant will remind the member of the event and help prepare for the occasion.

In one embodiment, members use their activity file as the portal to all of the services available from the proprietor. The activity file keeps members up-to-date on every aspect of the buying phase, selling phase and homeownership. The activity file tells you: when products and services the member has ordered will be delivered; when installations, connections and disconnections will be done; the status of each outstanding product and service order the member has; what the member has spent; and what the member has saved.

In one embodiment, members use the activity file to order additional purchases and schedule services, or inform the move consultant to manage such services for them. The activity file allows members to maintain and analyze records for all transactions related to home ownership, buying and selling. Secure, and always accessible, the activity files section 86 is an electronic storehouse for member mortgage papers, closing and settlement documents, records of home-related purchases and property taxes. The activity files track contact's purchases from vendors, helping the contact measure their savings while maintaining the records that establish the value added to the contact's home.

Further, the activity file can be a home maintenance organizer for members by: recording details about heating, air conditioning, pool, and other systems; notifying, with permission, when these systems need service; and informing members about member discounts for such services. Preferably, the move consultant schedules the service calls for the members if the member so desires. The activity file also records birthdays, anniversaries, vacations and other scheduled events. If desired by the member, the activity file will remind the member about upcoming deadlines and the move consultant will help members prepare for the upcoming event. Thus, the activity file content and features are convenient and customized to the member's personal preferences.

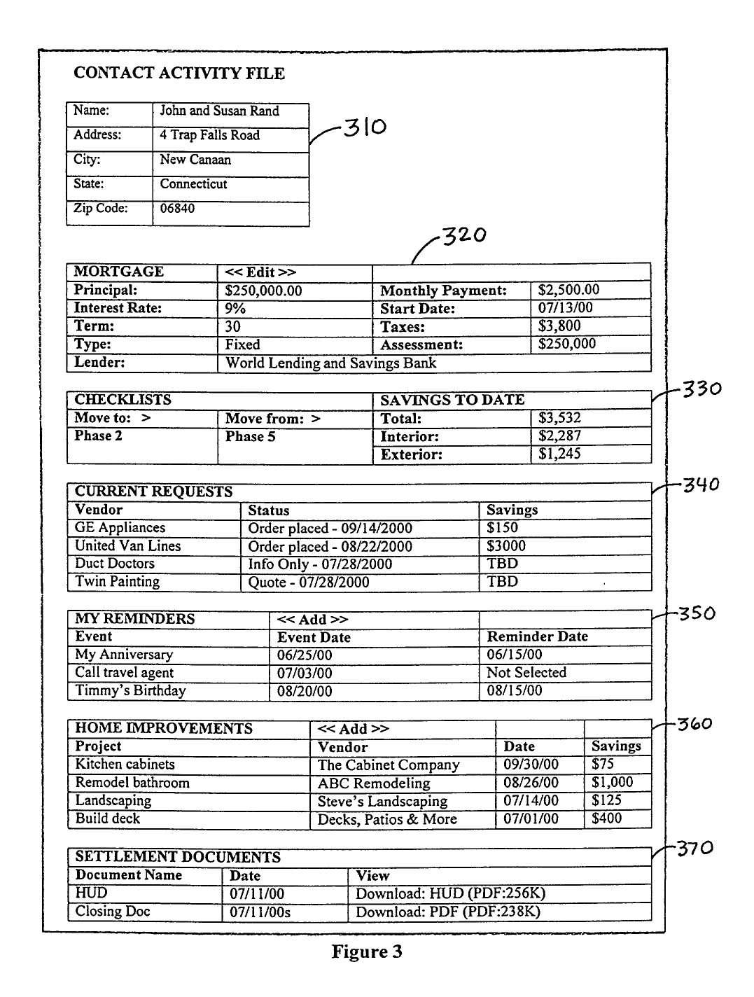

Referring now to FIG. 3, there is illustrated an exemplary Web page forming part of an activity file. Server 12 displays the contact activity file screen, designated generally by reference numeral 300. Contact general area 310 contains fields for holding contact name and address. Mortgage area 320 indicates the history of the contact real estate purchase. Preferably, the principal, interest rate, term, type, lender, monthly payment, start date, taxes and assessment are included in the history of the contacts real estate purchase. Checklist area 330 indicates any appropriate phase the contact may be in with respect to the buying and selling cycles. By selecting the phase, an associated checklist Web page (not shown) can be accessed. The checklist Web page items can be indicated as completed until all items are addressed and the next phase is entered. Further, the checklist area 330 shows the total savings the contact has garnered through participation in the proprietor's program. Additionally, the savings are subtotaled with respect to interior and exterior portions of the contact's home.

Current requests area 340 contains three columns for vendors, status and savings. The vendor column contains the name of any provider of goods and services engaged on behalf of the contact. The vendor may be any purveyor of goods and services. Preferably, the vendor offers discounts to members and provides a referral fee to the proprietor. The status column indicates information such as ordered, en route, quote, information only to allow the contact or move consultant to determine if any action or follow up with the vendor may be required. If the goods and services have been ordered, the saving column indicates the discount received by the contact in relation to the corresponding goods and services. The “My Reminders” area 350 allows the contact to track personal events and deadlines by name, date and tickler date. The name of the personal event is stored in the event column. The date is stored in the event date column. A tickler date provides advance warning of the upcoming event to the contact and is shown in the reminder date column. As shown, a contact would create additional personal event lines by selecting an add option contained within my reminders area 350.

Still referring to FIG. 3, home improvements area 360 establishes a record for the contact of the value which was added to the property. For example, four columns could represent the project, vendor, date and savings respectively. The project and vendor columns would indicate particular improvements to the contacts property and the entity which performed the task, respectively. Further, the date and savings would show when the project was completed and the savings received by the contact as a member of the program of the proprietor. As shown, a contact would create additional home improvements lines by selecting an add option contained within home improvements area 360. Settlement documents area 370 contains links to electronic copies of the contact's important documents. For example, a contact can obtain an electronic version of a closing document and store it within the proprietor's system. Settlement documents area 370 has three columns for the document name, date and view. The document name and date identify what documents are present and their respective dates. The view column indicates the place of storage within the proprietor's system and provides access when selected by the contact. Thus, the need for the client to maintain hard copies or a safety deposit box for their real estate related and other important documents becomes unnecessary.

### IV. Web Reporting Section

Referring once again to FIG. 2, Web reporting section 88 of Web site 80 provides a user interface to allow management to generate reports within authorized information constraints. For security, the potential users would include contacts, vendors, move consultants, managers of the proprietor and a marketing operations manager. The marketing operations manager has the function of maintaining the Web site 80 in an accurate and updated fashion. Preferably, the marketing operation manager has a list of responsibilities as follows: determines security protocols; creates and edits correspondence rules; creates, edits and deletes email templates; retransmits correspondence and service surveys; creates and edits letter and facsimile templates; adds, views and edits automatically generated tasks; reassigns contacts to move consultants; reassigns the tasks associated with contacts to different move consultants; adds and edits a move consultants records; adds, views and edits service categories and contact moving phase scripts; records vendor transaction payments; associates, views and edits completed service transaction fees with a vendor payment; adds and edits contact general information; edits a contacts service restrictions; edits a vendor's general information; adds and edits a vendor's contact information; adds and edits a vendor's contract information; adds and edits vendor's service information; creates vendor's Web advertisements; adds and edits clients, vendors, contacts and agents; and generates viewing reports. The marketing operation manager may be an employee of the proprietor of call center 40 or an employee of one of the entities using call center 40 for a usage based fee.

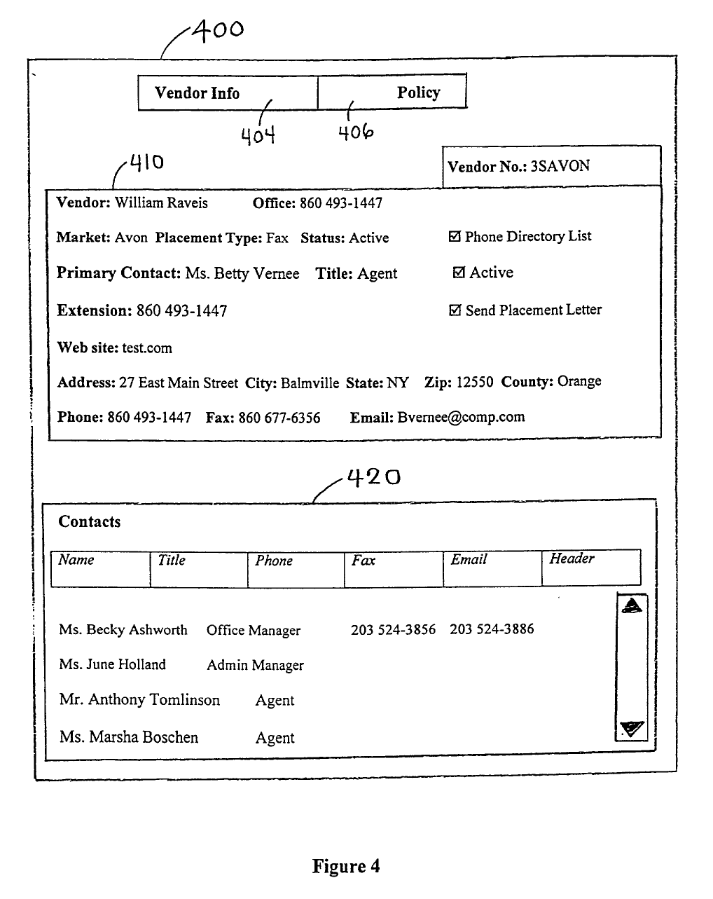

Referring to FIG. 4, an exemplary Web page relating to a vendor in accordance with the present disclosure is illustrated. Server 12 displays the vendor information screen, designated generally by reference numeral 400. Vendor general area 410 contains several user selectable fields such as vendor name, market region, primary contact, geographic address, email address, phone number, facsimile number, office phone number vendor number, status, Web site of the vendor, phone directory option and the like. Vendor general area 410 also contains a link to policy information associated with the vendor. Preferably, the marketing operation manager would enter such data for access by the move consultant. Vendor contact area 420 provides a name, title, phone, facsimile, email and the like for individuals associated with the vendor. Thus, a move consultant can locate specific individual information to effectively address the issues for which they need to contact the vendor.

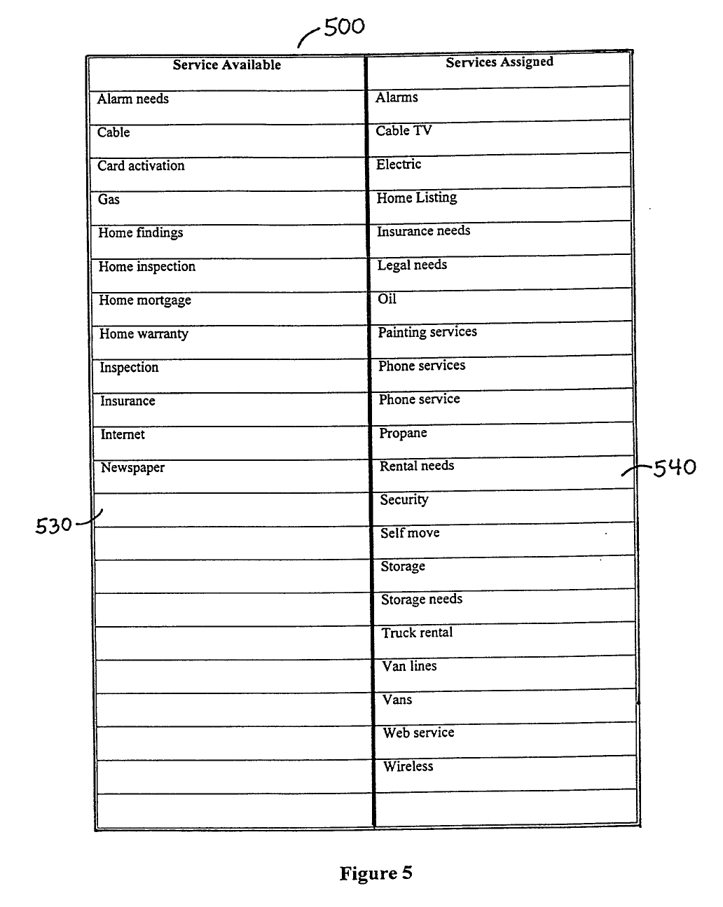

Referring to FIG. 5, an exemplary Web page relating to service provided to a contact is illustrated. Server 12 displays the services sold screen, designated generally by reference numeral 500. Generally, a move consultant would refer to the services sold screen 500 when discussing the management of a contacts need for goods and services. It is envisioned that the contact between the move consultant and contact is by telephone, email, direct mail and the like. Alternatively, a contact may directly access the services sold screen 500 to manage their affairs. Further, links may be provided from the services sold screen to vendors to facilitate providing requests for proposals and ordering goods and services.

With continuing reference to FIG. 5, services available area 530 indicates the potential goods and services which a move consultant can coordinate for the contact. Preferably, the services available area 530 indicates only goods and services not yet provided to the contact. Goods and services which the move consultant has already provided the contact are listed in services assigned area 540. In a preferred embodiment, the move consultant simply drags a service the client orders from the services available area 530 to the services provided area 540 to maintain the accuracy of the ledger of services sold screen 500.

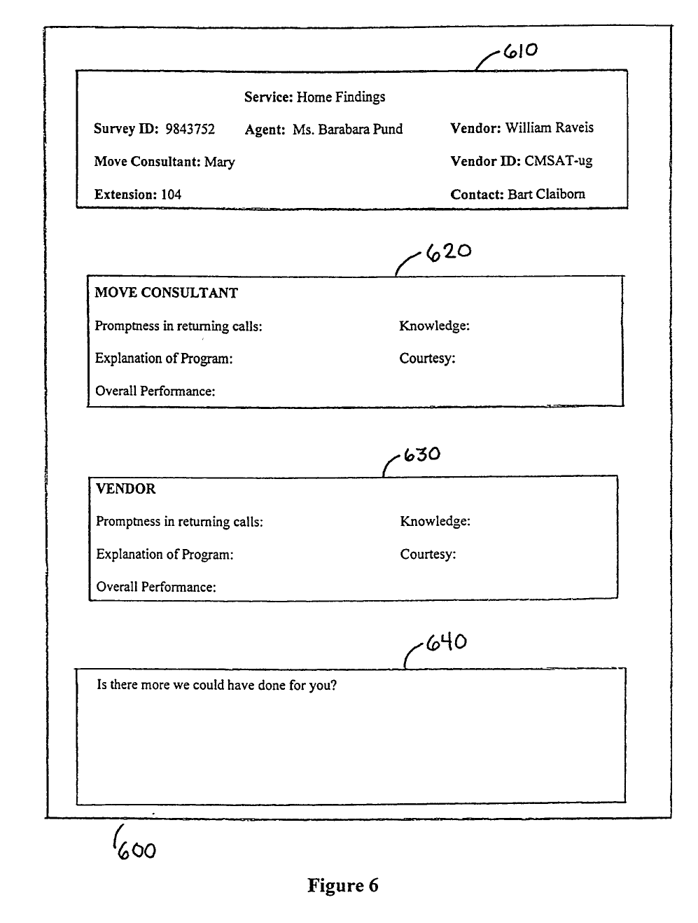

Referring to FIG. 6, an exemplary Web page relating to service evaluation is illustrated. Server 12 displays the service evaluation screen, designated generally by reference numeral 600. Generally, the service evaluation screen 600 is automatically sent via the Internet to each contact when a good or service is provided to such contact. Thus, feedback is generated which allows the proprietor of the subject invention to maintain a high level of quality from their own employees, vendors and third party entities using the program on a usage basis. The results of the survey form depicted in service evaluation screen 600 are used to calculate the vendor service rating and move consultant rating. In another embodiment, the survey form is printed and sent via mail or facsimile to the contact.

With continuing reference to FIG. 6, survey identification area 610 contains general information relating to the vendor and the goods or services provided. Preferably, survey identification area 610 includes a survey identifier, a service description, an agent, a counselor or move consultant with telephone extension, a vendor name, a vendor identifier and a contact. Alternatively, the survey identification area 610 could identify a party other than a vendor, as noted above. Move consultant area 620 contains questions relating to the performance of the move consultant assigned to the contact and Vendor area 630 contains questions relating to the delivery of goods and service provided by a vendor to the contact. In one embodiment, the move consultant area 620 includes questions relating to promptness in returning calls, explanation of the program of the subject invention, general knowledge, courtesy and overall performance. Similarly, the vendor area 630 includes questions relating to the promptness in returning calls, promptness in contacting the contact, general knowledge, courtesy and overall performance of the vendor. Open comment area 640 allows the contact to compose a free-form critique regarding the performance of the move consultant, vendor or any other aspect of the program implemented in accordance with the subject disclosure.

Although specific examples have been illustrated in FIG. 3, FIG. 4, FIG. 5 and FIG. 6, it will be appreciated by those skilled in the art that variations or modifications thereto will achieve the desired results necessary to practice the subject invention and as such is considered within the scope of the subject invention.

In one embodiment, third party entities utilize the software and know-how of the proprietor to establish a call center to meet only the needs of the third party entity. Further, such third party entities create Web sites similar to Web site 80. In return for the assistance, the proprietor receives a licensing fee from the third party entities and referral fees from goods and services placed through vendors.

In a preferred embodiment, the products and services that transform a house into a home are available through the move consultant and Web site 80, and managed, at the client's request, by the move consultant. Preferably, the move consultant develops a personal relationship with the client to recognize their needs, interests and schedule. Thus, the delivery of goods and services is convenient, easy and affordable for the client.

On an ongoing basis after a move, the move consultant will continue to offer the client quality service and products relating to the new home for as long as the client owns the home. Preferably, the services and products are available at discounts only through participation in a program in accordance with the subject disclosure. Such goods and services would include home repairs, home security systems, major appliances, lawn maintenance, exterior and interior painting and decorating, home cleaning services, home furnishings , environmental monitoring and controls, heating and Air Conditioning, travel planning and the like. The move consultant can place the order, track each transaction and measure the savings due to participation. The relationship between the client and move consultant evolves to where the move consultant is a homeownership manager for the client.

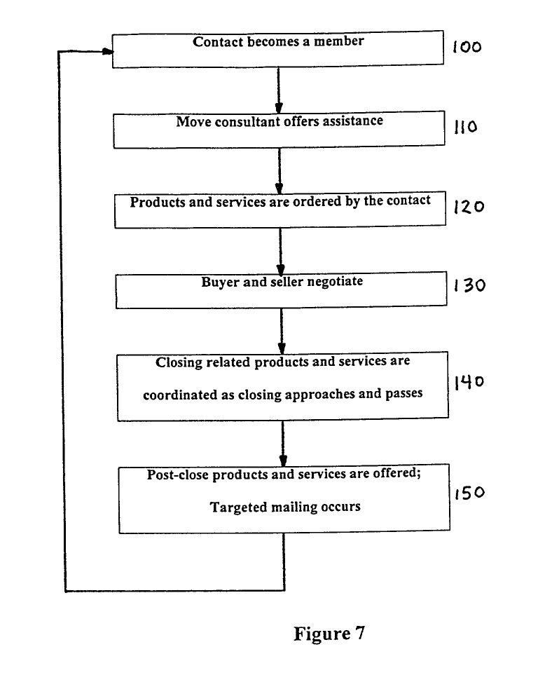

Referring now to FIG. 7, there is illustrated a flowchart depicting a process for managing a customer relationship based upon transactions relating to real estate in accordance with an embodiment of the present invention.

Initially, at step 100, when a contact decides to use the services of the real estate company, the contact signs an agreement with a real estate agent. A contact may be a potential buyer of real estate and/or an entity desiring to sell a particular piece of real estate. Therefore, the agreement may be a buyer agreement or an agreement that the contact will list their real estate through the real estate company, i.e., a listing agreement. As a result, a buyer and a seller would enter the “buying” and “getting ready” phases, respectively. Preferably, the proprietor of the subject invention would provide assistance with a sellers purchase of a new home as well as the sale of the seller's current residence. In such a circumstance, the agent would earn a commission from each transaction.

Upon engagement as a buyer or seller, the real estate broker assigns a move consultant to the member. The move consultant acts as an assistant to the agent. Thus, the agent is able to focus on listing, selling and locating homes for members. On behalf of the agent, the move consultant is also an assistant for the member. The move consultant is a professional specially trained to provide the member one-stop access to the services and products that people buying, selling and enjoying a home require. The move consultant works with the member to determine, schedule and coordinate all of the details of moving related with each phase of the buying and selling process. Such details include arranging movers, temporary storage, installing home security systems, making sure telephone and cable lines are connected, ordering appliances and maintenance services. The move consultant also helps keep the maintenance schedules that retain the value of the contact's systems and appliances. The agent as well as the move consultant establish personal relationships with the contact. The move consultant uses the Internet and the software of the subject invention to give the contact convenience, control and value via telephone or e-mail. The move consultant works closely with the agent of the contact during all phases of the home buying and selling processes.

For example, a move consultant will provide a reminder to a contact when annual cleaning of the heating and cooling system is required. For another example, a move consultant can facilitate opening and closing of a pool. If the member so desires, the move consultant can automatically schedule such routine maintenance and simply notify the member as to when the service will be performed. Any such offerings to the member by the move consultant are available at member discounts.

Still referring to step 100, the data relating to the contact and listing are entered into a computerized database which can be accessed through the Web site 80 by contacts and move consultants on an unlimited basis. The flexibility of remote access provides convenience for sales agents and, in turn, increased utilization. An agent can access information relating to each of their contacts and drill down with respect to any individual contact to determine the most up-to-date activity related thereto. Members have comparable access to activity related to their home transaction as well. Preferably, the Web site 80 display a picture of the member's agent with contact information. In a preferred embodiment, the proprietor of the subject invention hosts Web site 80 and a local area network or “LAN” to provide access to the features and advantages of the subject invention as discussed herein and as would be obvious to one skilled in the art after familiarization with the subject disclosure.

The subject invention provides for continuing communication with contacts by creating a series of different data tables. These tables are accessed and exported for direct mail merges. After the mail merge jobs have been completed and confirmed, the program marks the contact record and sets the flags within the listings database and sales database to indicate completion of the mailing. The subject invention also contemplates mining the data collected to publish a newsletter which is used as a marketing vehicle for the real estate company.

Still referring to step 100, a secure activity file, as described above, is created for the member. Preferably, the member has lifelong access to the secure activity file. The member can use the checklist provided within the activity file to prevent overlooking important details. Further, direct access via the Internet to vendors related to action items on the checklist is conveniently available via links within the activity file. Moreover, the member can scan documents and upload the electronic copies thereof for permanent storage with their activity file. Such documents would include, without limitation, warranties, receipts, settlement documents and title documents. As a result of the combination of the agent, move consultant and activity file, the stress associated with the moving event is minimized for the member.

Still referring to FIG. 7, at step 110, the move consultant assigned to the contact in combination with the agent assigned to the contact recommends vendors to supply various goods and services. The checklist associated with the current phase of the cycle provides a guideline for the appropriate goods and services. Sales agents with the help of the move consultant track contact activity.

At step 120, the move consultant coordinates delivery of products and services. Upon completion of delivery, a survey form is automatically sent to the contact. Thus, as noted above, the proprietor can maintain high quality standards. Such services may include improving the curb appeal of the seller's property. Additionally, once the seller's property is suitable for showing, the seller would enter the listing phase of the selling cycle. The move consultant and agent would continue to track activity related to the seller's property. For example, showing appointments and the improvements will be indicated in the activity file.

As the property of the seller is viewed, potential buyers may submit offers. Upon submission of an offer, the buyer enters the buying phase and the seller who receives the offer enters the negotiating phase at step 130. Preferably, the sales agent has also assisted the seller in the purchase of a new residence in the same general timeframe. It is also envisioned that the seller may have used a different sales agent for the purchase of their new residence because of geographical considerations and the like. In one embodiment, the seller who uses one sales agent to sell their property and another to purchase their new residence will only have one move consultant assigned to them because both agents will be part of the program of the proprietor.

Still referring to step 130, the buyer and seller negotiate to reach an agreement and determine a closing date. Several rounds of offer and counter-offer may occur. If the buyer and seller reach an agreement, each will enter the closing phase of the cycle.

At step 140, the move consultant offers goods and services related to closing such as mortgage services, title search, inspections, professional cleaning, utility hook-ups and the like. As members of the program run by the proprietor of the subject invention, the move consultant can coordinate the delivery of the goods and services desired by the contacts. Upon completion of all the contingencies, the buyer and the seller proceed to closing and with the help of the services coordinated by the move consultant, the closing occurs.

At step 150, the contact is enjoying their home and the move consultant remains in communication with the contact by email, telephone and mail as preferred. The on-going communication relates to offering post-closing goods and services. Additionally, a publication outlining the highlights of membership in the proprietor's program can be sent periodically to the contact. When the contact enters the thinking phase, the relationship between the sales agent and move consultant is already well established. As a result, a high percentage of members will reenter the cycle at step 100 as members of the proprietor's program and be maintained as a member for their entire life. Although the subject invention has been described with contacts entering at an exemplary phase, it will be appreciated that the subject disclosure envisions engaging the services of the proprietor of the subject invention at any phase and in varying capacities.

While the invention has been described with respect to preferred embodiments, those skilled in the art will readily appreciate that various changes and modifications can be made to the invention without departing from the spirit or scope of the invention as defined by the appended claims.

What is claimed is:

1. A method of managing customer relationships throughout a real estate transaction cycle over a distributed computer network, the method comprising the steps of:
a) receiving and storing data relating to a plurality of customers including buyers and sellers of real estate in a computerized database, the data including:
i) active order data describing real estate related services ordered during the real estate transaction cycle;
ii) completed order data describing real estate related services completed during the real estate transaction cycle;
iii) scheduling data describing real estate related services scheduled during the real estate transaction cycle;
b) updating the active order data, the completed order data and the scheduling data upon the performance of a real estate related service ordered during the real estate transaction cycle; and
c) providing customers with secure access to the computerized database to facilitate monitoring of the active order data, the completed order data and the scheduling data.

2. A method of managing customer relationships according to claim 1, further comprising the step of receiving and storing real estate related documents in the database for subsequent review and retrieval by a customer.

3. A method of managing customer relationships according to claim 1, further comprising the step of receiving and storing mortgage data relating to terms of a mortgage executed during the real estate transaction cycle.

4. A method of managing customer relationships according to claim 1, further comprising the step of providing a customer with an electronic checklist associated with each of a plurality of phases of the real estate transaction cycle to enable the customer to order real estate related services.

5. A method of managing customer relationships according to claim 1, wherein the active order data includes savings data indicating a discount amount received by the customer.

6. A method of managing customer relationships according to claim 1, wherein the completed order data includes savings data indicating a discount amount received by the customer.

7. A method of managing customer relationships according to claim 1, further comprising the step of receiving and storing non-real estate related scheduling data indicating at least one deadline date and an event associated with the at least one deadline date.

8. A method of managing customer relationships according to claim 7, further comprising the step of performing a task based upon the non-real estate related scheduling data at a request of a customer.

9. A system for managing customer relationships throughout a real estate transaction cycle, the system comprising:
a) means for receiving and storing data relating to a plurality of customers including buyers and sellers of real estate in a computerized database, the data including:
i) active order data describing real estate related services ordered during the real estate transaction cycle;
ii) completed order data describing real estate related services completed during the real estate transaction cycle;
iii) scheduling data describing real estate related services scheduled during the real estate transaction cycle;
b) means for updating the active order data, the completed order data and the scheduling data upon the performance of a real estate related service ordered during the real estate transaction cycle; and
c) means for providing customers with secure access to the computerized database to facilitate monitoring of the active order data, the completed order data and the scheduling data.

10. A system as recited in claim 9, further comprising means for receiving and storing real estate related documents in the database for subsequent review and retrieval by a customer.

11. A system as recited in claim 9, further comprising means for receiving and storing mortgage data relating to terms of a mortgage executed during the real estate transaction cycle.

12. A system as recited in claim 9, further comprising means for providing a customer with an electronic checklist associated with each of a plurality of phases of the real estate transaction cycle to enable the customer to order real estate related services.

13. A system as recited in claim 9, wherein the completed order data includes savings data indicating a discount amount received by the customer.

14. A system as recited in claim 9, further comprising means for receiving and storing non-real estate related scheduling data indicating at least one deadline date and an event associated with the at least one deadline date.

15. A system as recited in claim 14, further comprising means for performing a task based upon the non-real estate related scheduling data at a request of a customer.

16. A computer-readable medium whose contents cause a computer system to manage customer relationships throughout a real estate transaction cycle over a distributed computer network, by performing the steps of:
a) receiving and storing data relating to a plurality of customers including buyers and sellers of real estate in a computerized database, the data including:
i) active order data describing real estate related services ordered during the real estate transaction cycle;
ii) completed order data describing real estate related services completed during the real estate transaction cycle;
iii) scheduling data describing real estate related services scheduled during the real estate transaction cycle;
b) updating the active order data, the completed order data and the scheduling data upon the performance of a real estate related service ordered during the real estate transaction cycle; and
c) providing customers with secure access to the computerized database to facilitate monitoring of the active order data, the completed order data and the scheduling data.

17. A computer-readable medium as recited in claim 16, wherein the computer system further performs the step of receiving and storing real estate related documents in the database for subsequent review and retrieval by a customer.

18. A computer-readable medium as recited in claim 16, wherein the computer system further performs the step of receiving and storing mortgage data relating to terms of a mortgage executed during the real estate transaction cycle.

19. A system as recited in claim 16, wherein the computer system further performs the step of providing a customer with an electronic checklist associated with each of a plurality of phases of the real estate transaction cycle to enable the customer to order real estate related services.

20. A system as recited in claim 16, wherein the computer system further performs the step of receiving and storing non-real estate related scheduling data indicating at least one deadline date and an event associated with the at least one deadline date.
